(19) United States
(12) Patent Application Publication
(10) Pub. No.: US 2007/0266111 A1
(43) Pub. Date: Nov. 15, 2007

(54) Web-internet operating system-the next dimension of internet logic

(76) Inventor: Gunter H. Schubert, Live Oak, FL (US)

Correspondence Address: Gunter H. Schubert, 9566 114th Terrace, Live Oak, FL, 32060, US

(21) Appl. No.: 11/432,439

(22) Filed: May 12, 2006

(51) Int. Cl. G06F 15/16

(52) U.S. Cl. 709/217

(57) ABSTRACT

This is an Internet web operating system that uses the next dimension of an Internet program logic exchange that is embedded in the web site operating system and is working with Internet multiple requests and responses by using Internet multiple/multiplex server pages and is operating in an Internet control processor kernel.

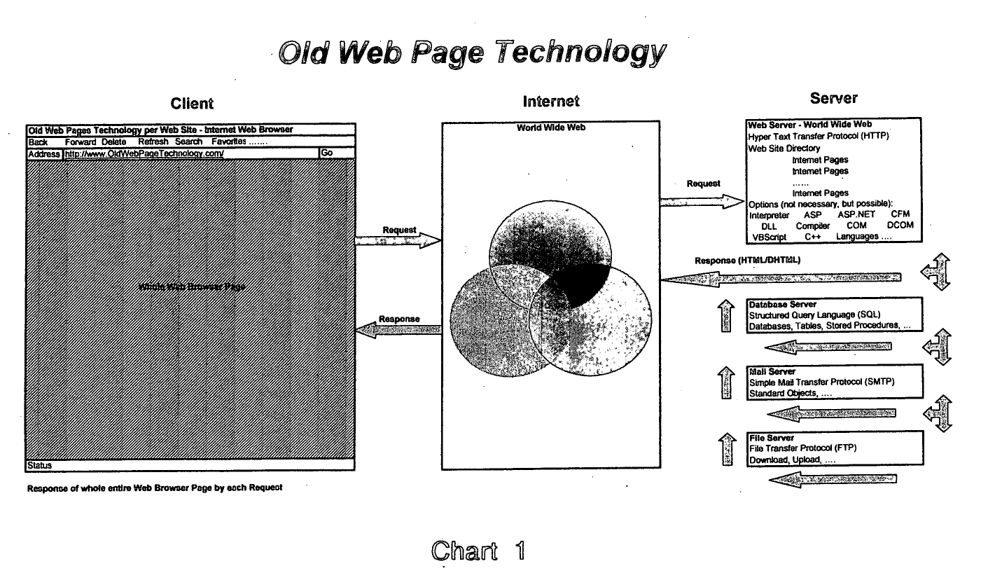

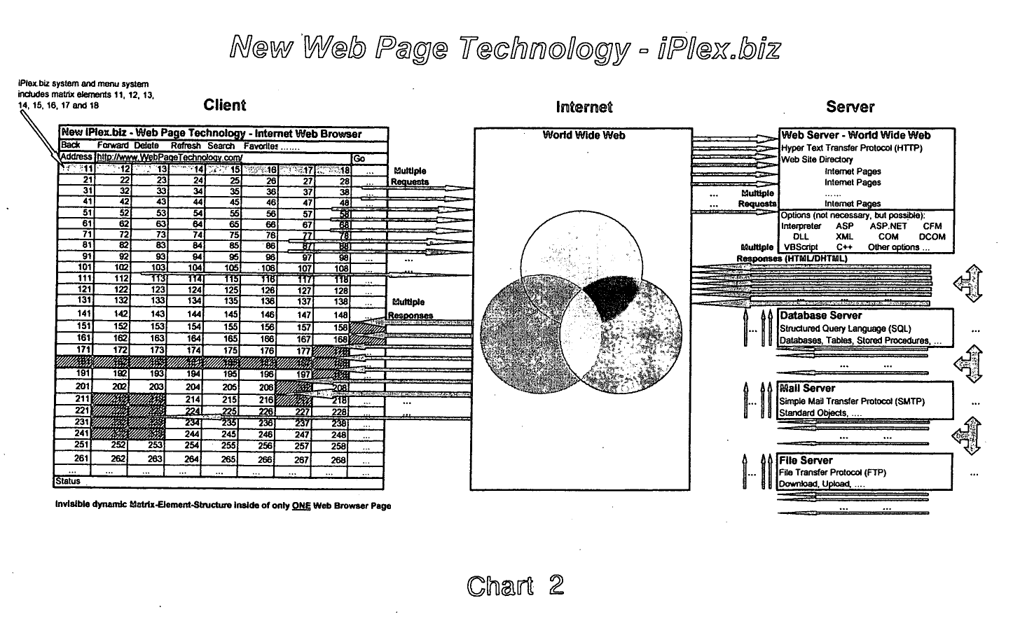

### BACKGROUND OF INVENTION

Until today, links or execution-buttons inside a web page call for another web page to open a new window. Each action generates a request to a specific web server. After finding the web server and the requested web page, the client or web user is waiting for a response from this server.

The requested web page always includes client-side HTML codes, even with the generation of different High-Tech program languages mixed with database content or objects for other pre-installed applications.

The disadvantage of all common program technologies is the sequential request of new web pages with redundancy like menu systems, header or footer lines. Mostly, the Internet client uses the common “back” button of Internet Browsers to find their way back to the previous web pages, even inside the same web site. Even some approaching program technologies in the past and the present like XML or combinations with XML are much too complicated, too time consuming, and too expensive for corporations, government or private customers to be developed in simple or complex web solutions.

The classic web application model works like this: Most user actions request a new web site via HTTP from a web server. The server does some processing—retrieving data, crunching numbers, talking to various legacy systems—and then return an HTML page to the client. It's a process adapted from the web's original use as a hypertext medium, but it does not necessarily make it good for software applications.

In addition, it is often confusing and very time- and traffic-consuming for the Internet user. In addition, on one hand most of the Internet users need faster Internet connections to be satisfied with the answer time in between request and response cycles. On the other hand, the Internet Service Providers (ISP) needs high speed backbone and high performance servers and connectivity equipment to be able to serve all clients in a timely manner.

### BRIEF DESCRIPTION OF THE INVENTION

iPlex.biz™ is a completely revolutionary Internet Logic, handling Client/Server processing inside the web site with an Internet Operation System like a computer system. iPlex.biz™ covers all the fundamental principles about the next dimension of web page technology in great detail. It has been successfully used on web applications of Motorola Corporation including On Demand Mode, Pre-Load Mode with Switch Today. iPlex.biz™ even includes bi-directional “Internet Multiple Server Pages” iMSP™, Client/Server Communication and Organization in a “Control Processor Kernel™” including Event Controller, Scheduler, Queue Spooler, Web Matrix Elements, Trigger, Priority Management, Semaphore Technology, Jobs, Links, Monitoring, Tracing, Data Passing Alternatives, Object Handling, Security, Source Code Protection and it excludes transfer redundancy.

iPlex.biz™ is not only a completely new Web Operation Technology and revolutionary Internet logic. It includes several new technologies from the same inventor in Computer Science and Information Technology. Each of them has its own right, but all comes together in simple new combinations of successful old and new techniques to a completely powerful next dimension of Internet web system logic and Internet web operating system technology.

iPlex.biz™ works with an Internet Web Operating System iWOS™ and it is independent on common Platforms, fast and dynamic between the client and the web server using simple the Standards of HTML/DHTML, without using anymore asynchrony or synchronic XML protocols, Plug In Components, COM/DCOM, Dynamic Link Libraries, (DLL's) or other related past or present technologies.

### DETAILED DESCRIPTION OF THE INVENTION

The invention is based on the Internet Programming Technology. iPlex.biz™ uses a completely new and novel technology, with hidden possibilities of how to create any number of web sites on only one major web page using similar Standards of HTML/DHTML technology. It is independent of common system platforms without having to always wait and start any new web pages and includes the dynamic generation of multiple client/server processing, database connectivity and all other related issues. In addition, this new invention shows the secrets of the simple hidden opportunities of multiple processing of HTML/DHTML, ASP, ASPX, CFML or other web server executed processes.

When using this new technology, the worldwide. Internet Traffic will be reduced up to 85%, because it is not using unnecessary redundancy. The time saving of multiple executions of complex web based solutions without the redundancy will speed up the Internet Downloading Time tremendously.

The inventive concept uses completely new and hidden methods to create links to all web pages of a domain in one major page, without going back or forward, and without opening new windows or starting a new web page. It splits the one web page into one invisible dynamic matrix. All requests will be executed automatically and multiple, using iPlex.biz™ Web Operating System Programming. The Internet users will be able to get all information and still always stay inside the same web page they requested, without reloading the whole web page content again.

### What is iPlex.biz™

It controls the front to back and back to front communication path in bi-directional multiple modes.

It is a communications platform technology for sending and receiving data interactively, bi-directionally synchronously.

It works on most common platforms for clients and servers.

It doesn't need additional application servers like J2EE, Macromedia, Cold Fusion Server, or XML, MS, ASP, NET, etc. but it works with them too.

It is flexible to provide clients faster real-time requested information.

It is using economy Internet transfer capacities, it works even on low speed Internet connections with more efficiency.

It is not blocking the Internet connections with the present percentage of redundancy.

It is using the chosen security and standards of HTTP and HTML/DHTML.

It has the flexibility and reliability that modern transaction-based applications require.

It is providing a guaranteed communication path between the client and the server.

It is up to 100 times faster or more than common web based client/server applications.

It is easy to navigate inside the web application without always using the back and forward button.

It does not need to reload and refresh the entire web page after receiving requested server-side code including data.

It is acting interactively by using the keyboard or mouse between the client and the server.

It is working without having to submit requests and their responses from the server within the entire web page.

It is an Open Web Technology and could be used in most existing client/server applications.

It does not show any data or source code as security protection.

It is working as a dynamic pre-load/switch mode or on demand mode controlled by client events or automatic time controllers.

### Where iPlex.biz™ can be Useful

iPlex.biz™ can be useful in all Internet web sites, especially, in complex Internet applications have absolute needs for this new technology such as: e-Auctions, e-Commerce, e-Stock Market, e-Logistics etc., and almost all other applications too numerous to mention here.

It is the future of worldwide applications unsolved via web until today.

It will define the next developing of potential program applications in the next Dimension.

It also will enhance the existing web based solutions like “eBay” and Amazon, Dell and web solutions which are powered by IBM and other client/server web applications with fast dynamic and complex data supplies.

With the rise of always-on Internet connections in homes and businesses, and the continued explosive growth of the World Wide Web and Internet accessible applications, it is becoming more and more important for applications to be able to provide clients with fast dynamic data each time it is requested.

### Brief Description of the Flow Charts

Flow chart 1 describes the current Web Page Technology;

Flow chart 2 describes the technology using the next dimension of the Web Page Technology.

### Detailed Description of the Flow Chart 1

Flow chart 1 describes the current Internet Web Page technology.

1. Using the Internet via World Wide Web requires two parts: The server that houses the domain or web site including all web pages and the applications for sending them out, and the client using a computer including a web browser from which one sends a single request and then reviews the received document.

2. The classic web application model works like this: The browser must first make a connection to the server that houses the web site or domain name. User actions request an entire new web page in side of a specific domain name or web site via HTTP from a web server.

3. When one is using a web browser and type in a web address or click on a link, what actually happens is that one has to wait for the entire web page content to load. After finding the web site through the Internet and the requested web page, the client or web user is still waiting for a response from this addressed server by using a domain name or IP address.

4. The server does some processing such as: retrieving data, crunching numbers, talking to various legacy systems like to a database server, mail server, file server or pass by, and then returns an HTML or DHTML web page to the client. It's a process adapted from the web's original use as a hypertext medium, but it doesn't necessarily make it good for software applications even when using active server pages, cold fusion action pages, XML, PHP or other related techniques.

5. The speed at which the page down loads depends on several factors: speed of the Internet connection that one is using, the speed and count of active users of Internet Service Providers, The server's own processing capacity, how busy the server is, and how large the file and objects like images are that the browser is downloading. Once the file is downloaded to one's machine, it displays the same in the browser's window.

6. The current web page technology is often confusing and very time- and traffic-consuming for the Internet user. On one hand, most of the Internet users need faster Internet connections to be satisfied with the answer time in between requests and response cycles of the entire web page content. On the other hand, the Internet Service Providers (ISP) needs a high speed backbone and high performance server and connectivity equipment to be able to provide for all of its clients in a timely manner.

7. Until today, links or execution buttons inside of a web page call for replacing of another web page or open a new window. Each action always generates a request to a specific web server. The requested web page always includes client-side HTML, DHTML codes or both, even with the generation of different High-Tech program languages mixed with database content or objects for other pre-installed applications on the client's machine.

8. The disadvantage of all common program technologies is the single and sequential requesting and replacing of new web pages with redundancy like menu systems, header and footer, always again and again.

9. Mostly, the Internet client uses the common “Back” button of Internet Browsers to find their way back to the previous web pages, even inside the same web site. Even some approaching program technologies in the past and present like XML or combinations, are much too complicated, too time consuming, and too expensive for corporations, and for government or private customers to be developed in simple or complex web solutions.

### Detailed Description of the Flow Chart 2

1. The next Dimension of the Internet Web Page Technology known under the Trade mark iPlex.biz™ is a completely novel Internet Programming Logic Exchange™ which is embedded in an Internet Web Operating System™ (iIOS™) and is working with Internet Multiple Requests and Responses™ (iMRR™ while using the Internal Multiple/Multiplex Server Pages™ (iMSP™) which is operating in an Internet Control Processing Kernel™ (iCPK™). iPLex.biz™ covers all the fundamental principles of the next dimension of web page technology.

2. The result of iPlex.biz™ is a continuous web page, rather than the necessity to move from one page to another. iPlex.biz™ technology ends the current practice of moving forward or backward, or always down loading and replacing new web pages inside one specific domain name.

3. iPlex.biz™ controls web applications including On-Demand Mode, Pre-load Mode with Switch Execution, Multitask, Semaphore Technology, bi-directional Internet Multiple/Multiplex Server Pages (iMSP™), Client/Server Communication and Organization operating in an Internet Control Processor Kernel (iCPK™).

4. The Control Processor Kernel includes modules like Event Controller, Scheduler, Queue Spooler, Web Matrix Elements, Priority Management, Multitask, Semaphore Technology, Jobs, Links, Monitoring, Tracing, Data Passing Alternatives, Object Handling, Security, Source Code Protection and it excludes Transfer Redundancy.

5. iPlex.biz™ can simply be included in most common web applications.

6. iPlex.Biz™ is operating independently on common platforms, fast and dynamic between the client and the web server simply by using the standards of HTLM/DHTML without having to use asynchrony or synchrony XML protocols, Plug In Components, COM/DCOM, Dynamic Link Libraries (DDL's) or other related past and present technologies.

7. iPlex.biz™ is a combination of an inventive Multiple/Multiplex Web Site Logic Exchange and the first Internet Web Operating System (iWOS™).

It works automatically, operating in an Internet Control Processor Kernel (iCPK™). Using client and server based scripting which displays the final product, or all kinds of web site requests in the form of a movie rather than isolated sub parts of web pages.

8. The idea of using the iPlex.biz™ is the Internet web Operating System (iWOS™) which is managing a virtual matrix with many elements of the main web page. It works through an automatic multiple/multiplex independent bi-directional transportation system via “Internet Multiple/Multiplex Server Pages” (iMSP™) Technology.

9. iPlex.biz™ splits the client's web site in an invisible grid with independent object functions. Those multi-functional objects automatically get multiple requests and multiple responses from server pages in specific matrix elements of the main web page.

10. iPlex.biz™ will use dynamic progress indicators between client requests and server responses.

11. iPlex.biz™ can generate new static and/or dynamic client script inside the server code, depending on previous client event handlers. It also has the ability to start client script functions from the web server.

12. iPlex.biz™ is changing the whole client web navigation process inside of one main web page in real multiple modes. It is using bi-directional Internet Multiple/Multiplex Server Pages (iMSP™), organizing and triggering in an Internet Control Processor Kernel (iCPK™) on a Web Server and being controlled by the client as the Internet user.

13. iPlex.biz™ works as an organized multiple or multiplex execution of all detailed virtual web site contents, even with the option of programmable timers.

14. iPlex.biz™ works for all event handlers regarding all kinds of possible replacements, merges, splits or flashing up objects. They can be menus, controls, guides, movies, pictures, legends, maps, text, animations, select boxes, radio buttons or check boxes, input fields, buttons, tables, even flash animations or new server content including database information. The data can come from parts of active server pages or action pages with SQL database support like Active Data Objects or other program content. All are client-server based.

15. The internal invisible Internet Control Processor Kernel (iCPK™) works as a multi-task and multi-user operating system, like all common computer systems with MS-Windows Systems or UNIX Derivates, but iPlex.biz™ is web based and executes very fast through unlimited multiple processing features, with all necessary server-side codes by using task and semaphore technology in the background.

16. The “user” or “client” can use either the mouse or the keyboard to initiate one or more requests or events.

17. Each of the user requests will be handled by multiple levels of unlimited multiple client requests and multiple background executions/responses of server-side scripts.

18. After the unlimited multiple executions of all server-side scripts, one or more client-side responses will be generated multiply on the server.

19. iPlex.biz™ will be promptly sent back embedded into the client-side web page in all those specific elements of the virtual matrix where it needs to appear, like a flash movie.

20. All requests or events also can be initialized by automatic dynamic time control triggered functions, whenever values or ranking informations are changing in real-time.

21. iplex.biz™ will always be refreshing in real-time via fast unlimited multiple client/server executions of all different data objects inside the same client-side web page without any manual refreshing of the web sites. iPlex.biz™ can be used for all web applications, especially, where dynamic values will be displayed in real-time, like most complex web solutions, especially, e-commerce systems, auction systems, stock market systems or data processing systems, with measured and fast changing values.

22. iPlex.biz™ redefines not only the way the web site looks, but also the way the client navigates through only one static web page. Including all events controlled by unlimited common functionalities and the speed at which they conduct business. Each element of the virtual matrix has the ability of invisibility or visibility and zooming, resizing, exchanging, etc.

23. With the current web page technology, Spy-ware or Ad-ware appears mostly by each refreshing of the web pages or opening new windows. With the current technology, once this unfortunate event occurs, most people become acutely aware of their actions in an effort to prevent the same from happening again. iPlex.biz™ does not refresh the web page with new web pages or opens new windows. It is only exchanging elements of the virtual matrix of the necessary content inside the web page.

24. By using iPlex.biz™, there is no need or reason to publish any additional web content in a new pop-up window like print version, view basket, detailed descriptions, etc.

25. iPlex.biz™ is able to operate multiple or even multiplex—“Internet Multiple/Multiplex Server Pages” (iMSP™) depending on the ability of web servers system settings, using multiprocessor systems, parallel support, threat handling, etc., inside of the same domain name of a web server.

26. iPlex.biz™ works even by using multiple domains or sub-domains on the same web server or by using different distributed web servers.

What I claim is:

1. An internet web operating system including the steps of operating said: system by embedding an internet program logic exchange in said web operating system, working with an internet multiple request and response inquiry by using Internet multiple/multiplex server pages while operating in an Internet control processing kernel

2. The Internet web operating system of claim 1, wherein said web operating system controls feed backs that result in a continues web page without the necessity of moving from one page to another.

3. The Internet web operating system of claim 1, wherein said system is operating independently on a common platform.
